(19) United States
(12) Patent Application Publication
(10) Pub. No.: US 2007/0273895 A1
(43) Pub. Date: Nov. 29, 2007

(54) Efficient Whole Page Printing

(75) Inventors: Richard Anthony Cudd, Ealing (GB); Jeremy David Michael Thorp, New South Wales (AU); John Stewart Reeves, New South Wales (AU)

Correspondence Address: FITZPATRICK CELLA HARPER & SCINTO, 30 ROCKEFELLER PLAZA, NEW YORK, NY, 10112, US

(73) Assignee: Canon Information Systems Research Austrialia, New South Wales (AU)

(21) Appl. No.: 10/581,276

(22) PCT Filed: Dec. 10, 2004
(86) PCT No.: PCT/AU04/01744

§ 371 Date: Apr. 9, 2007

(30) Foreign Application Priority Data
Dec. 12, 2003 (AU) 2003906918

(51) Int. Cl. G06F 17/00

(52) U.S. Cl. 358/1.1; 358/1.2; 715/500; 715/527

(57) ABSTRACT

Disclosed are methods of printing documents comprising a plurality of pages sourced from a computer network. The methods provide a zoom property attribute to scale the document (FIG. 10). In one implementation a preview window (1702,1703) is displayed which shows the pages in the document scaled based on the zoom property attribute. A user selection (1701), within the preview window, is then determined for the pages of the scaled document. A subset (1804 cf. 1802) of the pages according to the user selection are then printed. In another implementation it is determined whether an amount of content (1008) on a last page of a scaled multi-page document (1002), which is scaled based on the zoom property attribute, is less than a predetermined amount. When the amount of content (1008) is less than the predetermined amount, the scaled multi-page document is further scaled down to fit to a nearest whole page. The further scaled multi-page document (1010) may then be printed.

### FIELD OF THE INVENTION

The present invention relates to printing documents, such as HTML web page documents and, in particular, to the printing and scaling of documents to fit the nearest whole page.

### BACKGROUND

Many computer based systems exist which are designed for the creation and viewing of documents. Many of these systems also provide mechanisms for printing documents. Word processing applications typically display a view of a document as it would appear on a printed page whilst the user is still in the editing process. Most will require the user to select a paper size in which to create the document. This allows the user to obtain a feel for how a document would look when printed whilst the document is in the process of being created. At the very least, many word processors will provide an indication of where one printed page will finish and another will begin. Since these applications create documents to fit a particular paper size, there is never any need for scaling or resizing of pages before printing.

Other applications such as spreadsheet tools enable the creation of documents which are not necessarily specifically designed to be printed. A user can see a preview of how the spreadsheet would look on a printout but they are not required to create the document to fit a paper size. In this case the user may create a document that would not entirely fit on a particular paper size or may unnecessarily overlap by a very small amount onto a final page and thus waste paper. This problem has been addressed to some degree by Microsoft® Excel™, a spreadsheet application manufactured by Microsoft Corporation. Excel™ provides the ability to fit a spreadsheet to X pages wide by Y pages tall when printing. This will fit the spreadsheet correctly to the number of pages preferred by the user.

Web pages are predominately designed to be viewed within a web browser window on a computer display and are thus not optimized for printing. When printing web pages, it is common that content may be clipped on the right hand side of the page because the content is too wide for the paper size. Some applications, such as Netscape Navigator®, manufactured by Netscape Communications Corporation, and Canon® Easy-WebPrint™ (see www.canoneasywebprint.com) apply automatic scaling to the content to prevent this clipping and fit the all the content on the page. However, this does not solve the problem of the web page content overlapping onto a final page by only a very small amount. An example of this is shown in FIG. 4 where a document 400 has been printed with content filling a first page 402, but flowing over onto only a first line of a second page 404. Products such as Canon® Easy-WebPrint™ 2.0 and Netscape Navigator® 7.0 provide the ability to manually scale the content of web pages when printing. This allows the user to repeatedly reduce the size of the content until the content fits onto the nearest whole page. This approach requires manual intervention.

### SUMMARY OF THE INVENTION

It is an object of the present invention to substantially overcome or at least ameliorate one or more problems associated with existing arrangements. The present disclosure affords methods of detecting a small overlap and scaling the web page to remove the overlap.

In accordance with one aspect of the present disclosure, there is provided a method of printing a document, said document comprising a plurality of pages sourced from a computer network, said method comprising the steps of:

providing a zoom property attribute to scale the document;

displaying a preview window which shows the pages in the document, the context of which is scaled based on the zoom property attribute;

determining a user selection, within the preview window, for the pages of the scaled document; and

printing a subset of the pages according to the user selection.

Typically, the user preference is determined for each page and the user preference is determined using a checkbox arranged in the vicinity of the previewed pages.

According to another aspect of the present disclosure there is provided a method of printing a multi-page document sourced from a computer network, said method comprising the steps of:

providing a zoom property attribute to scale the content in the multi-page document;

determining whether an amount of content on a last page of a scaled multi-page document, which is scaled based on the zoom property attribute, is less than a predetermined amount; and

when the amount of content on the last page is less than the predetermined amount, further scaling the content in the multi-page document down to fit to a nearest whole page and printing the further scaled multi-page document.

In accordance with another aspect of the present disclosure, there is provided a method of printing a document sourced from a computer network and spanning a plurality of printable pages, the method comprising the steps of:

determining whether an amount of content on a last page of the printable pages is less than a predetermined amount; and

when the amount of content is less than the predetermined amount, scaling the content down to fit the content to the nearest whole page and printing the content.

According to another aspect of the present disclosure, there is provided a printing application program arranged for printing a document sourced from a computer network and spanning a plurality of printable pages, the program comprising:

code arranged to determine whether an amount of content on a last page of the printable pages is less than a predetermined amount; and

code, operable when the amount of content on a last page is less than the predetermined amount, for scaling down the content to fit the content to the nearest whole page and printing the content. The computer network typically comprises the World Wide Web and the printing application program is configured to interact with a web browser application program having an associated graphical user interface, the printing application program further comprising code arranged to display via the graphical user interface both a print preview of the document spanning the plurality of pages and a print preview of the document scaled to the nearest whole page.

Numerous other aspects are also disclosed.

### BRIEF DESCRIPTION OF THE DRAWINGS

At least one embodiment of the present invention will now be described with reference to the drawings and appendices, in which:

FIG. 1 shows a modified toolband used in the Internet Explorer™ style web browser application incorporating the custom print option of the present disclosure;

FIG. 2 is a schematic block diagram of a general purpose computer upon which arrangements described can be practiced;

FIG. 3 depicts a custom printing approach for Internet Explorer™;

FIG. 4 shows an example of a print which overflowed onto a second page;

FIG. 5 shows the print template element behaviours;

FIG. 6 shows a prior art process of creating a print with a print template;

FIG. 7 shows a flow chart of a modified printing process;

FIG. 8 shows the threshold LAYOUTRECT;

FIG. 9 shows a flow chart of the modified printing process including the dialog box prompt;

FIG. 10 shows a print preview with the normal print at the top and the scaled print at the bottom;

FIG. 11 shows a print preview with the print type selected by highlighting;

FIG. 12 shows a print preview with the print type selected by right clicking;

FIG. 13 shows an interactive approach for varying the threshold LAYOUTRECT;

FIG. 14 shows a dialog approach for varying the LAYOUTRECT threshold;

FIG. 15 shows a portion of the browser window illustrating a print check box;

FIG. 16 illustrates a preview of pages that are not selected and that are selected for printing from the browser window;

FIG. 17 shows a print preview format within the browser window;

FIG. 18 shows detail of a selected page from the print preview of FIG. 17;

FIG. 19 shows a portion of a browser window incorporating a selection dialog for screen layout;

FIG. 20 illustrates a preview selection of a frames page in the browser window;

FIG. 21 shows various representations of frame arrangements from any of which selection for printing may be made; and

FIG. 22 is a flowchart of a method of printing a document.

### DETAILED DESCRIPTION INCLUDING BEST MODE

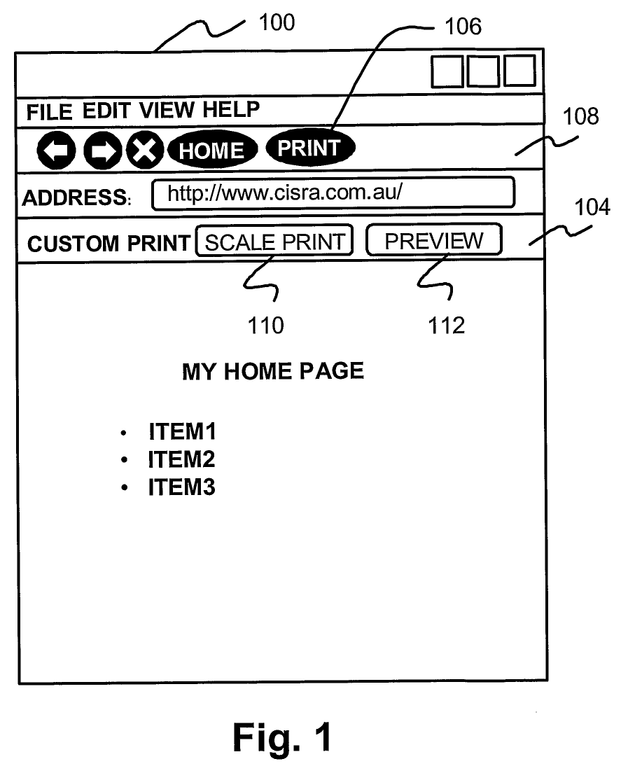

The present disclosure proposes a printing application, termed herein as “custom print”, which is preferably implemented as an add-on toolband to a generic web browser application, such as Internet Explorer™ 5.5 or 6.0, both manufactured by Microsoft Corporation. An example of this is seen in FIG. 1 where part of the Internet Explorer™ 6.0 style graphical user interface (GUI) 100 is shown. The GUI 100 may include known toolbands (not illustrated) that permit access to search engines and associated facilities. A further toolband 104, developed for customised printing as part of the present disclosure, is provided to enable customised printing of web pages. It is observed that the custom print toolband 104 is distinct from a generic print icon 106 contained in a primary toolband 108 of the GUI 100. In this connection, the selection of the print icon 106 will result in traditional printing of the web page displayed by the GUI 100 according to the generic browser application (eg. Internet Explorer™ 6.0), whereas selection of a print icon 110 or a print preview icon 112 found within the custom print toolband 104 will enable printing in the fashion according to the present disclosure and now to be described with reference to the remaining drawings.

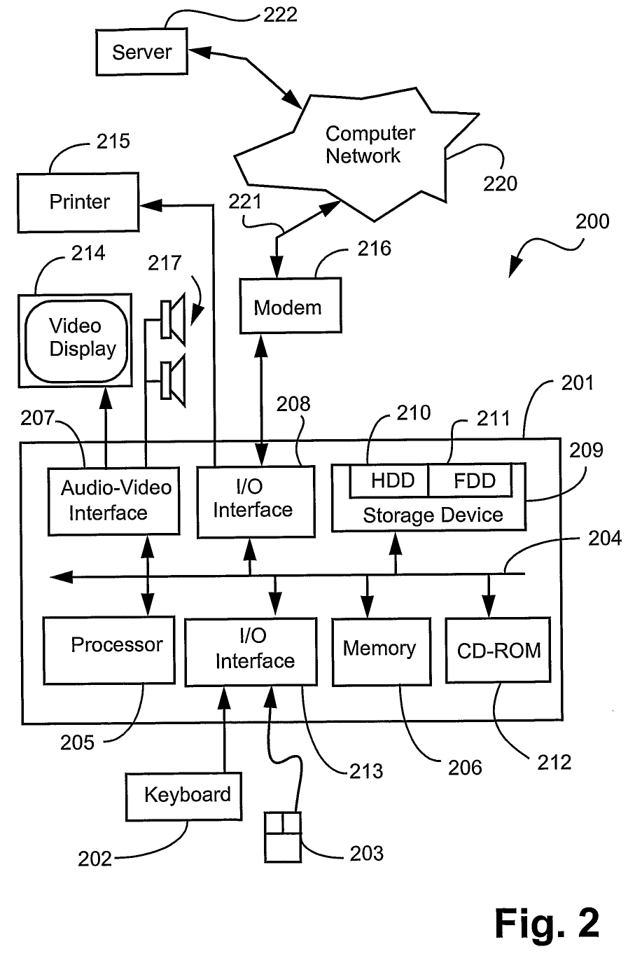

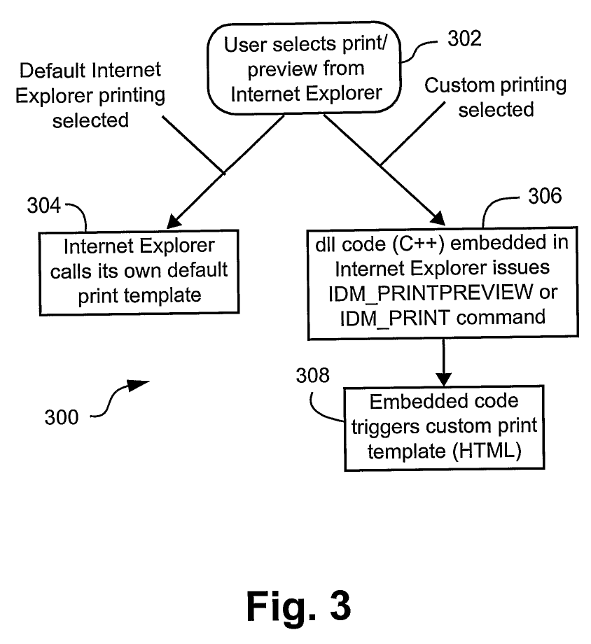

The method of customised printing is preferably practiced using a general-purpose computer system 200, such as that shown in FIG. 2 wherein the processes of FIGS. 3 to 12 may be implemented as software, such as an application program executing within the computer system 200. In particular, the steps of method of customised printing are effected by instructions in the software that are carried out by the computer. The instructions may be formed as one or more software code modules, each for performing one or more particular tasks. The software may also be divided into three separate parts, in which a first part that performs the browsing methods, a second part that performs the customised printing methods and a third part that manages a user interface between the first part and second parts and the user. The third part incorporates the GUI 100 including the toolband 102 and the icons 110 and 112. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for customised printing of individual elements of structured documents such as web pages. The application program for customised printing may operate in concert with a web browser application also operating within the computer system 200.

The computer system 200 is formed by a computer module 201, input devices such as a keyboard 202 and mouse 203, output devices including a printer 215, a display device 214 and loudspeakers 217. A Modulator-Demodulator (Modem) transceiver device 216 is used by the computer module 201 for communicating to and from a communications network 220, and is connectable via a telephone line 221, for example, or other functional medium. The modem 216 can be used to obtain access to a server 522, the Internet, World Wide Web and other network systems, such as a Local Area Network (LAN) or a Wide Area Network (WAN), and may be incorporated into the computer module 201 in some implementations.

The computer module 201 typically includes at least one processor unit 205, and a memory unit 206, for example formed from semiconductor random access memory (RAM) and read only memory (ROM). The module 201 also includes an number of input/output (I/O) interfaces including an audio-video interface 207 that couples to the video display 214 and loudspeakers 217, an I/O interface 213 for the keyboard 202 and mouse 203 and optionally a joystick (not illustrated), and an interface 208 for the modem 216 and printer 215. In some implementations, the modem 2116 may be incorporated within the computer module 201, for example within the interface 208. A storage device 209 is provided and typically includes a hard disk drive 210 and a floppy disk drive 211. A magnetic tape drive (not illustrated) may also be used. A CD-ROM drive 212 is typically provided as a non-volatile source of data. The components 205 to 213 of the computer module 201, typically communicate via an interconnected bus 204 and in a manner which results in a conventional mode of operation of the computer system 200 known to those in the relevant art. Examples of computers on which the described arrangements can be practised include IBM-PC's and compatibles, Sun Sparcstations or alike computer systems evolved therefrom.

Typically, the browser application program, by which a user of the computer 200 access the Web, is resident on the hard disk drive 210 and read and controlled in its execution by the processor 205. Intermediate storage of the program and any data fetched from the network 220 may be accomplished using the semiconductor memory 206, possibly in concert with the hard disk drive 210. In some instances, the application program may be supplied to the user encoded on a CD-ROM or floppy disk and read via the corresponding drive 212 or 211, or alternatively may be read by the user from the network 220 via the modem device 216. Still further, the software can also be loaded into the computer system 200 from other computer readable media. The term “computer readable medium” as used herein refers to any storage or transmission medium that participates in providing instructions and/or data to the computer system 200 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 201. Examples of transmission media include radio or infra-red transmission channels as well as a network connection to another computer or networked device, and the Internet or Intranets including e-mail transmissions and information recorded on Websites and the like. Actuation of the print icons 106 or 110 causes the respective print functions to effect printing using the printer 215, for example.

The modem 216 enables the user of the computer 200 to access a web page via the network 220. The web page may be resident on the server computer 222 and accessible via a Web address defined by a Uniform Resource Locator (URL) to thereby reproduce content to the user, typically via the display 214. Typically the browser application activates the GUI 100 upon the display 214 by which the content and other information associated with the web page is presented.

S From Internet Explorer™ version 5.5 onwards, it has been possible to customize how that web browser application previews and prints documents. The mechanism for printing and previewing is controlled by print templates, which are HTML files that developers can create to control the layout and look of a print job. The HTML files contain JScript code (a Microsoft version of JavaScript™, developed by Sun Microsystems and Netscape Inc.) that is used for manipulating content and accessing objects within the print template. While print templates are HTML files, they can only be applied by making calls from within code written in a programming language such as C++. This code is loaded as a dynamically linked library (.dll) file and embedded in the web browser application, thereby enabling the web browser application to issue IDM_PRINT or IDM_PRINTPREVIEW commands. These are the commands that are used for normal printing, such as via the icon 106, and print previewing by Internet Explorer™ and provide the path to the new print template. Browsers traditionally interpret the source HTML file by parsing the HTML code to create the corresponding DOM which, of itself, models the hierarchical structure of the web page. The DOM can be used to both manipulate and process the currently loaded document.

FIG. 3 demonstrates how custom print templates according to the present disclosure are called from C++ code. A method 300 of processing printing commands is shown which operates as part of the GUI 100. In a first step 302, the browser application detects and determines a user selection of print or print preview from the GUI 100. Where default Internet Explorer™ printing is selected, for example via the icon 106, step 304 allows Internet Explorer™ to call its own default print template so as to print in a traditional fashion. Where step 302 detects selection of custom printing via the icons 110 or 112, step 306 follows where the C++ .dll code embedded in Internet Explorer™ issues a corresponding IDM_PRINT or IDM_PRINTPREVIEW command. Step 308 then follows where the embedded code triggers the custom print template for HTML pages.

By creating print templates and toolbands, it is possible to control:
(i) the layout of pages when printed/previewed, and the content that is printed/previewed on them;
(ii) how print jobs are handled—for instance, which pages are printed, and in what order; and
(iii) the look of the print preview window and controls available on the print preview user interface.

A print template in Internet Explorer™ is written using standard HTML, JScript and four element behaviours specific to print templates, those being:
DEVICERECT
LAYOUTRECT
TEMPLATEPRINTER
HEADERFOOTER

These four new element behaviors are used within print templates in the following fashion:

DEVICERECT—A DEVICERECT element represents a page to be printed or viewed in print preview. The number of physical pages printed will correspond to the number of DEVICERECT elements within the print template. The DEVICERECT will have width and height properties that correspond to the width and height of the physical page. These are obtained by querying the TEMPLATEPRINTER element.

LAYOUTRECT—LAYOUTRECT elements define the area or areas (and their styles) on a page where a document's (web page) content is displayed when printed or during print preview. In a print template, LAYOUTRECT elements are contained by the DEVICERECT elements described previously. A DEVICERECT can contain more than one LAYOUTRECT. As well as width and height properties, the LAYOUTRECT also has a zoom property that can be used to scale its content. This zoom property is used in the present disclosure for scaling content to fit a page. To add content to a LAYOUTRECT, the contentSrc attribute can be passed a URL string. The web page content pointed at by the URL will then load or “flow” into the LAYOUTRECT.

TEMPLATEPRINTER—The TEMPLATEPRINTER element provides a number of methods that give a print template control over the start and end of print jobs, control over the printing of each individual page in a print job, and control over the display of printing dialog boxes, such as the standard Print and Page Setup dialogs found in versions of Internet Explorer™ and in various Windows™ operating systems, manufactured by Microsoft Corporation. The properties of TEMPLATEPRINTER enable a print template to set or retrieve the page setup settings and current print job settings. For instance, a print template may set or retrieve the page width and page height for page setup, or the start and finish pages to determine the page range to print.

HEADERFOOTER—The HEADERFOOTER behaviour is a conversion tool used by the print template to generate HTML from the header and footer formatting strings defined by the Page Setup dialog box. The element contains properties textHead and textFoot that can be used to insert text headers and footers on the page to be printed. This often includes information such as the page URL and the page number.

The relationship between some of these elements is illustrated in FIG. 5 which shows a print preview GUI 500 and various rectangles depicting the elements discussed above.

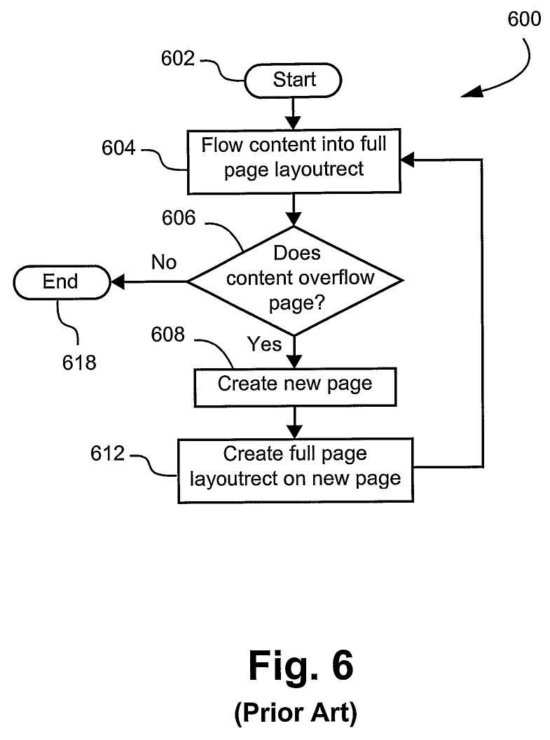

The basic process 600 of creating a traditional web page print according to Internet Explorer™ is shown in FIG. 6. At a start step 602, a DEVICERECT is created for the first page of the print job, and a LAYOUTRECT is placed upon the DEVICERECT to house the web page content. At step 604, the web page content is then loaded or “flowed” into the LAYOUTRECT. Step 606 tests if the content of the page overflows the bounding area established by this LAYOUTRECT. Such an overflow is generally indicated by a software event occurring within the Application Program Interface (API) associated with the Internet Explorer™ print function. Step 606 as such tests for the occurrence of this software event. If no overflow occurs, then the content is able to be reproduced on the current (the first) page, and the process 600 ends at step 618. If the content overflows the LAYOURECT, as detected by the software event, a new page, being a DEVICERECT, is created at step 608. A new LAYOUTRECT is then placed upon that DEVICERECT at step 612 to house the excess content. Control then returns to step 604 and the process continues until there is no more content left to add. In this fashion, the print job, “builds” the appropriate number of pages in order to satisfy the amount of content.

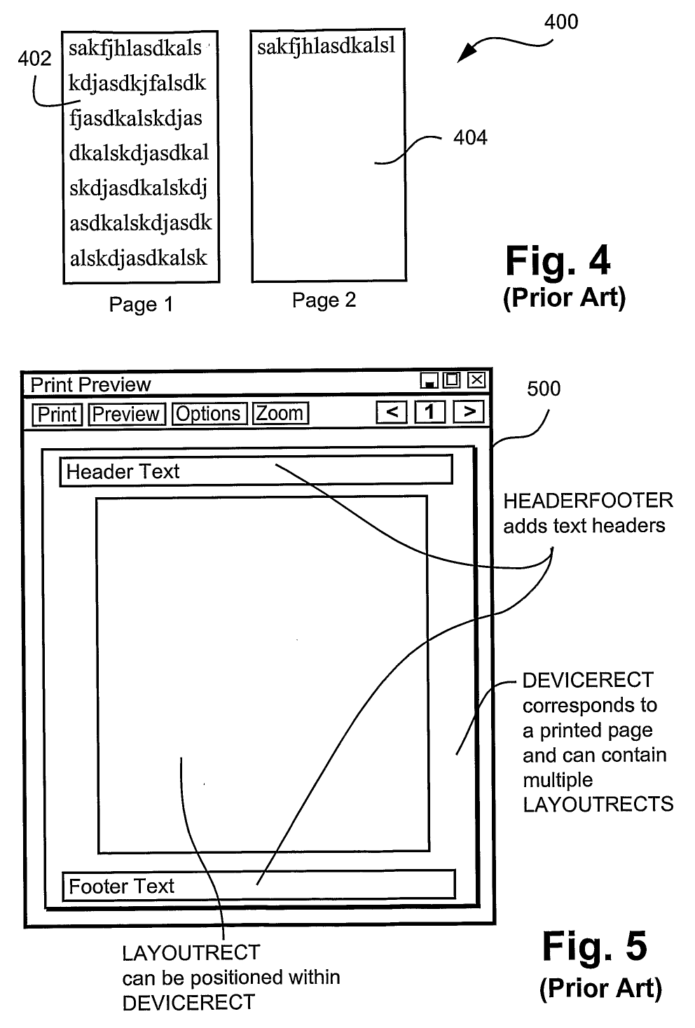

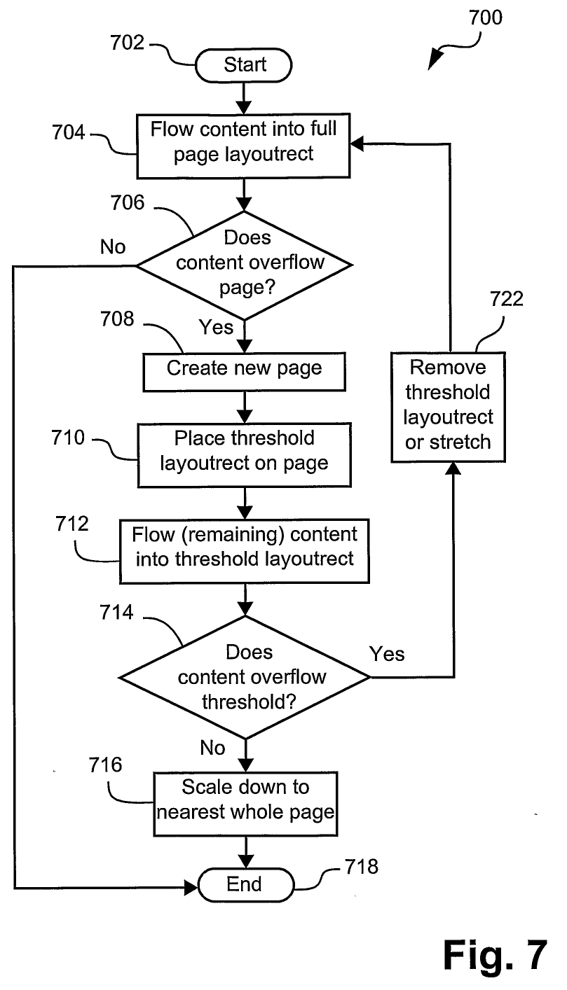

In order to provide a check to see whether the content has “only just” overlapped onto the last page of the print job, as illustrated in FIG. 4, a modified process 700 as shown in FIG. 7 may be used.

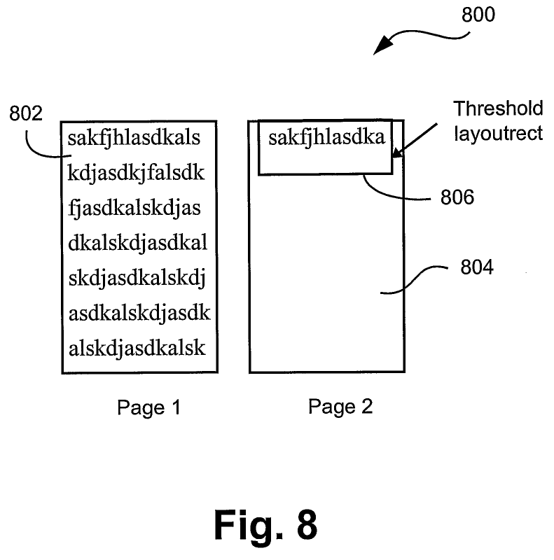

In the process 700, steps 702, 704, 706 and 708 each correspond respectively to steps 602, 604, 606 and 608 just described. However, each time a new DEVICERECT is added to the print job in step 708, and subsequently a new LAYOUTRECT is placed upon it in step 710, this LAYOUTRECT is set to be the height of a user defined or predetermined threshold. An example of this is shown in FIG. 8 where a print job 800 has two pages 802 and 804. A “threshold” LAYOUTRECT 806 is created which is limited to only a portion of the normal page height. Then, according to step 712, the content that overflows from the previous page 802 flows into this small LAYOUTRECT 806, as illustrated.

A test is performed in step 714 to determine if the content overflows the small threshold LAYOUTRECT. If so, control passes to step 722 which operates to remove the threshold LAYOUTRECT, thereby facilitating insertion at step 704 of a full-size LAYOUTRECT. As an alternative, step 722 may operate to stretch (ie. re-size) the threshold LAYOUTRECT to a new size, such as that corresponding to a full page size. If the content does not overflow the small LAYOUTRECT 806, indicating that the content is less than the size of the small LAYOUTRECT 806, then the content is considered to have overlapped onto the final page by only a small amount. If this is the case, then all the content contained in the print job is scaled down to the nearest whole page according to step 716. The scale factor used is calculated as the total height of all the whole pages divided by the total height of all the whole pages plus the threshold height.

In the example of FIG. 8, if the threshold height is 20% of the page height, then the scale factor will be (1/(1+0.2))=0.83. Step 716 alters (reduces) the size of the content by the scale factor to fit the content onto the page 802 and the process ends at step 716. Step 716 operates to expunge the additional, now empty page 804 from the print job. The process ends at step 718.

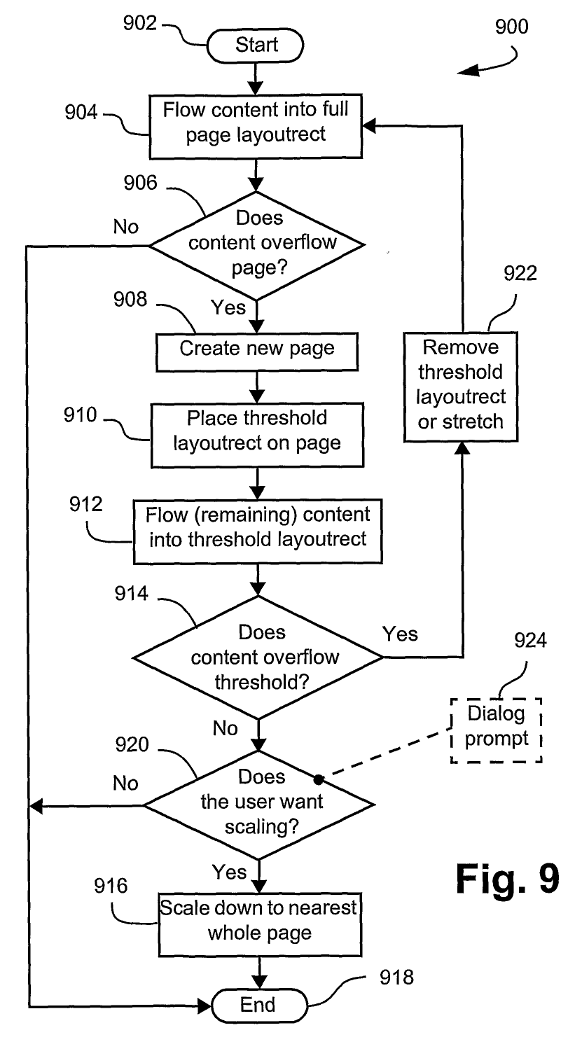

FIG. 9 shows an alternate process 900 in which steps 902-918 and 922 each correspond respectively to those of steps 702-718 and 722 described above. In this implementation, step 920, which is inserted between steps 914 and 916, operates to present the user with a dialog box, depicted at 924 in the instance where the content is determined to have overlapped onto the final page by only a small amount. The dialog box operates to prompt the user as to whether they wish to scale the content to the nearest whole page, or just to continue with a normal print. If scaling is selected, step 916 follows as previously described. Alternatively the process 900 ends at step 918 and a traditional number of pages are printed.

The above described implementations reply upon the content laying-out and overflow signalling mechanisms of Internet Explorer™. The testing for overflow requires Internet Explorer™ to calculate internally how much content is to flow into each LAYOUTRECT on a DEVICERECT page before it can determine whether or not an overflow occurs. The content must be re-laid out each time a threshold LAYOUTRECT is placed on a page. For large documents, this has significant performance implications.

As an optimisation to the method described above, the custom print application can quickly calculate the minimum number of pages (MIN) that will be required. For each page whose page number is less than or equal to MIN, that page will always be required. Therefore, the custom print application can save calculation time by simply placing a “full size” LAYOUTRECT on such pages. The application will only use a threshold LAYOUTRECT on pages whose page number is greater than MIN.

This minimum number of pages (MIN) is calculated by creating a very large (many, many pages long), hidden, “calculation” LAYOUTRECT. This “calculation” LAYOUTRECT is given the same width as the LAYOUTRECTs that will be used on each DEVICERECT page. The total height (TH) of the document as laid out in the “calculation” LAYOUTRECT is divided by the height (H) of the LAYOUTRECTs that will be used on each DEVICERECT page. The result of TH/H, rounded down to the nearest integer, gives MIN. If MIN is 0, then MIN is reset to 1.

When Internet Explorer™ lays out the content in the LAYOUTRECTs, it is possible for parts of the content (eg. images) that would overlap page breaks to be pushed onto the “next” page. When this happens, the scaling calculation that results form using the threshold LAYOUTRECT may indicate that the number of pages required should reduce, but when the layout is complete, the number of pages required has not reduced. If this happens, the custom print application will reduce the scale factor again and re-layout. If this newly reduced scale factor successfully reduces the number of pages required, then this newly reduced scale factor can be used for the printout. If this newly reduced scale factor does not reduce the number of pages required, then the original scale factor is used for the printout.

The threshold LAYOUTRECT may be altered in a number of ways. Because of the operation of the Internet Explorer™ program, such alteration is best performed prior to the commencement of the methods 700 or 900, or within the corresponding start steps 702 and 902. One reason for altering the threshold is to avoid “overscaling”, which may result in content being scaled down to a size which is too small in a user's opinion, and thus negates any advantage obtained by printing the document on one less page.

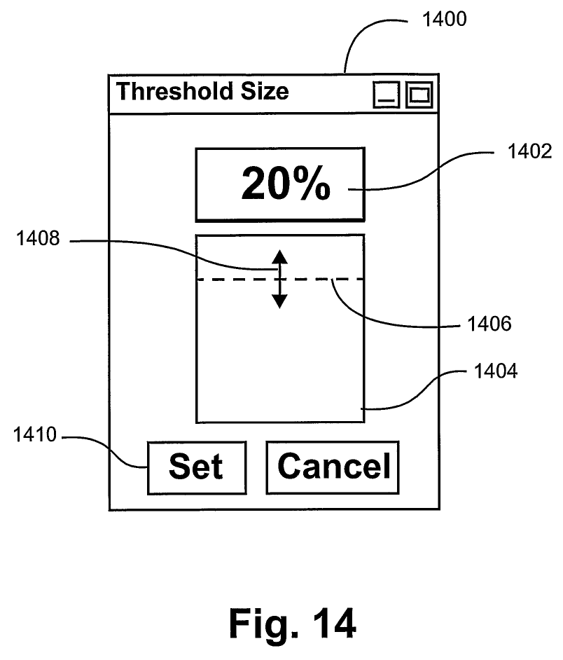

One approach to such altering is to present the user of the computer 200 with a dialog box 1400 as shown in FIG. 14. The dialog box 1400 is a subsidiary graphical user interface to that associated with the web browser and indicates the size 1402 of the threshold as a percentage of the page size and also provides a representation 1404 of a page illustrating the threshold 1406 corresponding to the values 1402. With this, the user may re-enter the threshold by typing over the size indication 1402. Alternative, the user may select the threshold line 1406 from the representation 1404 using the mouse 203 in a traditional fashion and reposition the threshold 1406 by way of a drag operation, as indicated by the arrow 1408. The drag operation is constrained to be either up or down, and not sideways. During such a drag operation, the numerically represented threshold 1402 may automatically be updated according to the repositioning of the threshold 1406. When satisfied with a desired value of the threshold, the user may select “SET” 1410 to establish the threshold, and then permit the methods 700, 900 to proceed.

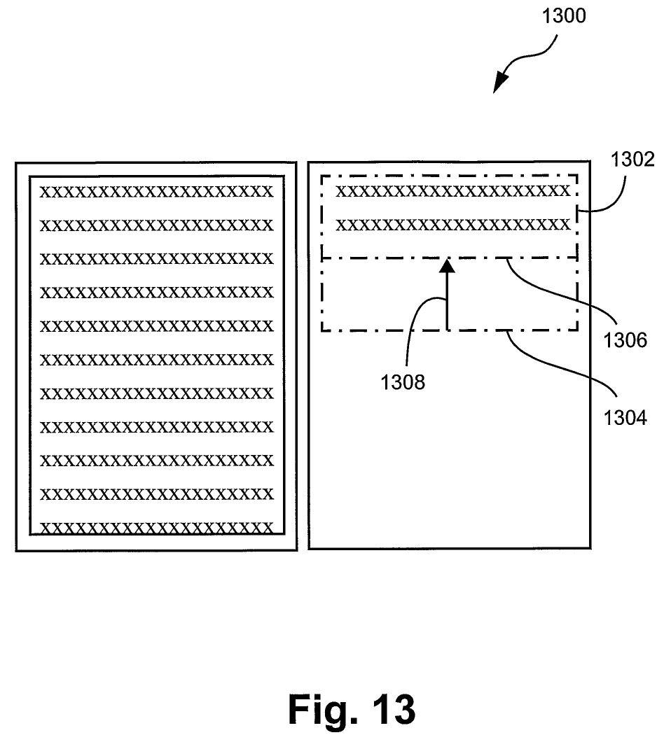

A further user interaction may be desirable where the size of the threshold LAYOUTRECT is larger than the amount of content that it is required to contain. In this instance, the user may choose to reduce the size of the threshold LAYOUTRECT to a size that neatly accommodates the overflow content. Scaling may then be performed with a larger scale factor than would have been available with a fixed threshold LAYOUTRECT. The initial threshold LAYOUTRECT in such an implementation may be indicated in a print preview type display 1300 as shown in FIG. 13, by a selectable bounding box 1302 superimposed upon the print preview display. The bounding box 1302, when selected, by a mouse click for example, allows the user a (further) attempt to adjust the presentation of the content. The user may move the lower extremity 1304 of the bounding box 1302 in an upward direction (indicated by the arrow 1308) to a position 1306 to reduce the size of the bounding box 1302. This has the same effect of altering, in a constrained fashion (ie. by reduction only), the percentage size of the threshold. Once the threshold LAYOUTRECT is reset, the methods 700 or 900 may then be implemented to achieve the desired reduction onto a smaller number of pages, but at a larger scale factor than otherwise would have been use had a default threshold size been relied upon.

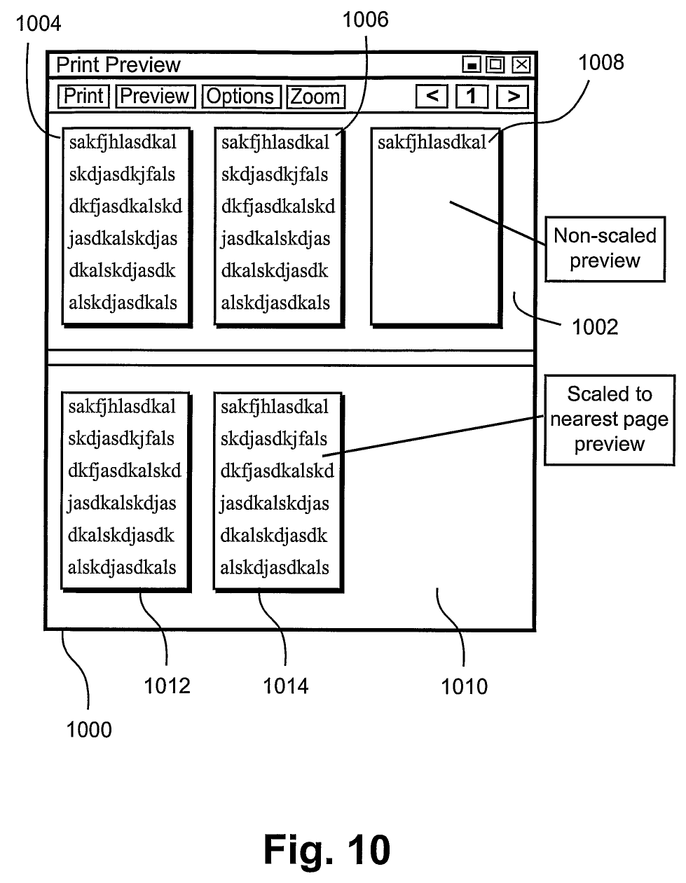

FIG. 10 shows an example of a print preview GUI 1000 that may be presented to the user before actual printing occurs. The print preview 1000 includes a traditional print preview 1002 of a document spanning three printable pages 1004, 1006 and 1008 and which occupies one half of the GUI 1000. The other half of the GUI 1000 is occupied by a print preview 1010 of the same document scaled according to the processes of FIGS. 7 or 9 and which includes two completely filled printable pages 1012 and 1014. The print job in this case has been scaled to the nearest whole page.

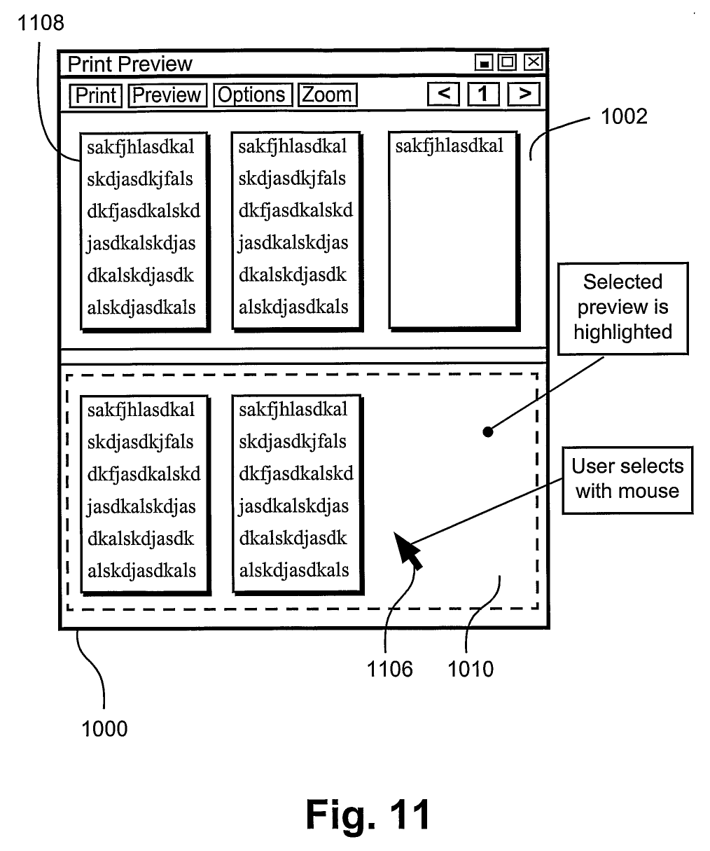

With reference to FIG. 11, the user can then select in the print preview 1000 whether they would like to print the normal or scaled versions of the print job. In one implementation, this selection can be made by positioning a pointer cursor 1106 associated with the mouse 203 within the desired print preview (1002 or 1010) and clicking the mouse 203. The selected type of print can then be highlighted, as illustrated in FIG. 11 for the scaled preview 1010, and will be printed upon user selection of the print button icon 1108.

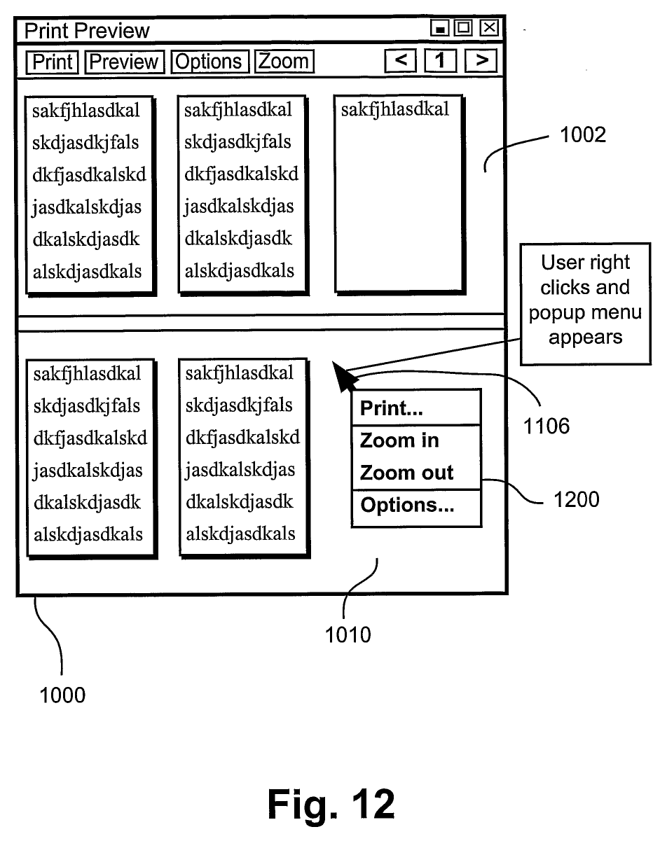

In a further alternative, illustrated in FIG. 12, the user may perform the selection by right clicking the mouse 203 whilst the cursor 1106 is positioned on the half of the preview screen containing the type of preview desired to be printed. A popup menu 1200 will appear allowing the user to print as well as providing a number of other operations such as changing the zoom or displaying other options. These operations may each be instigated from the popup menu 1200 via the GUI 1000 in a traditional fashion.

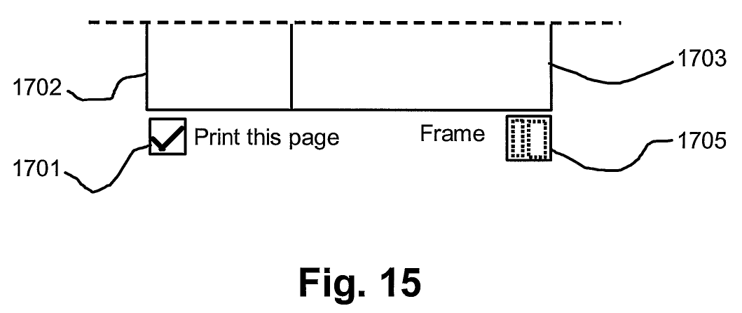

In addition to the threshold described above, FIG. 15 illustrates “Print this page” as follows. In the print preview window, each individual page to be printed is provided with an associated checkbox 1701 located in the vicinity of the page at the left-hand side corner just below the page 1702 FIG. 15. Each checkbox 1701 has the text “Print this page” displayed next to the checkbox 1701. The check state of the checkbox 1701 determines whether or not the custom print application is to print the associated page. By default, checkboxes for all pages are selected when the initial print preview window pops up. A user therefore can deselect a checkbox 1701 by clicking the checkbox 1701 using the mouse pointer 203 if such was selected. The user can also select the checkbox 1701 again by clicking the checkbox 1701 if it was deselected.

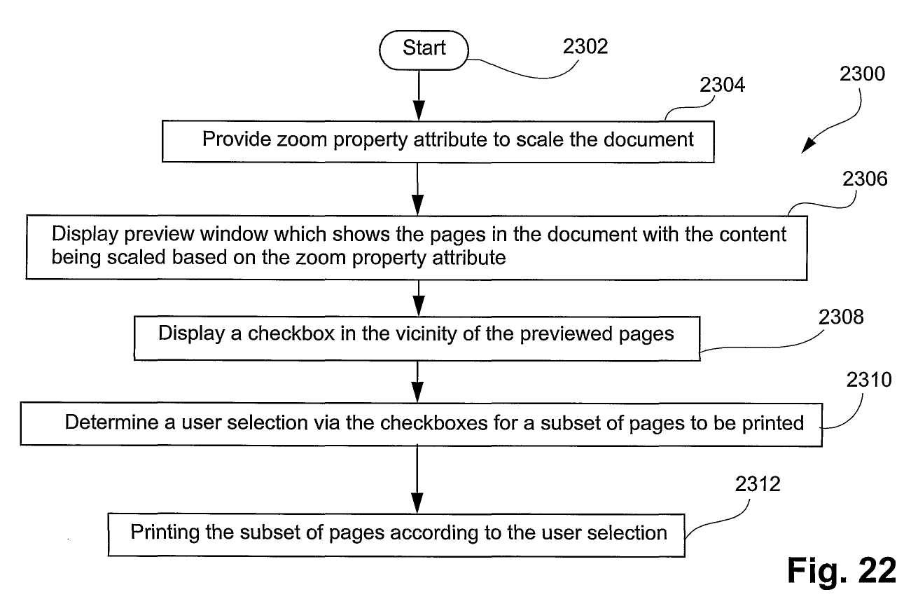

A preferred method 2300 of printing in this fashion, which may be implemented as software in the computer 200 is shown in FIG. 22. The method 2300 starts at step 2302 for a document comprising a plurality of pages sourced from a computer network. At step 2304 a zoom property attribute is provided to scale the document. At step 2306, a preview window is displayed via the display 214 which shows the pages in the document, the content of which is scaled based on the zoom property attribute. Step 2308 operates to display a checkbox in the vicinity of the previewed pages, preferably with one checkbox for each previewed page. Step 2310 determines a user selection, within the preview window, a subset of the pages of the scaled document intended for printing. This may be done by checking the checkboxes for a tick selection via the GUI. Finally step 2310 operates to print the subset of the pages according to the user selection.

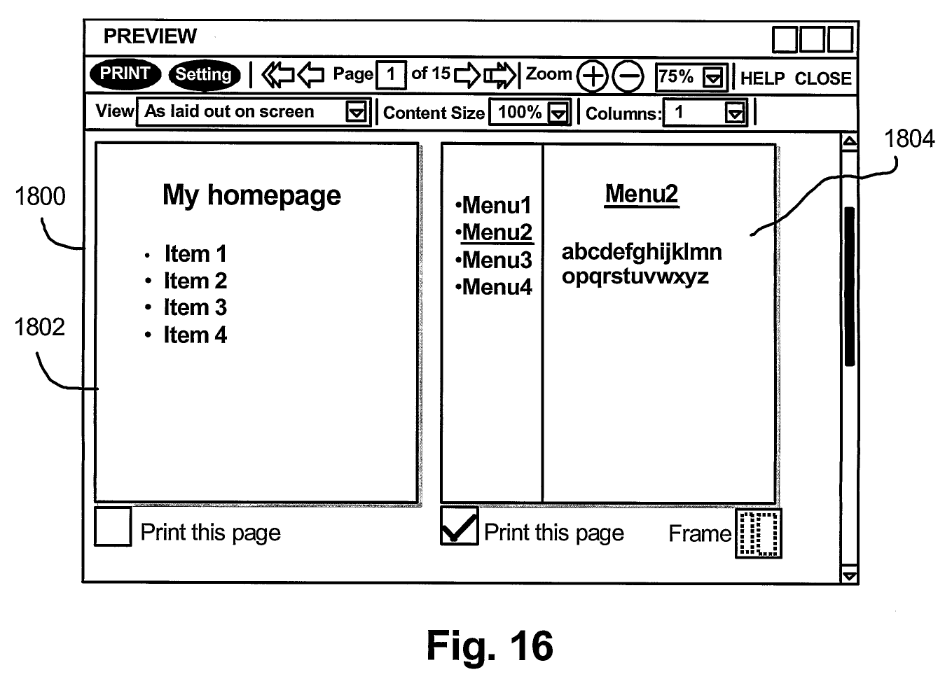

In a preferred implementation, when a checkbox 1701 is deselected, its associated page 1702 may be faded or otherwise altered in its rendering top the display 214 so as to give a clear visual clue of those pages that will not be printed. The fading effect of a page is removed when the user selects the checkbox 1701 again (i.e. the page will display in the normal print preview fashion). As an example, FIG. 16 shows a print preview window 1800 with a faded deselected page 1802 on the left hand side, and a normal selected page 1804 on the right hand side.

The custom print application can maintain the checkbox state even if page content relocation occurs due to events such as the column number changing and/or the frame view changing resulted from the user's action. Therefore, the pages can restore their visual clue when the user changes the setting back, for example, changing back the column number to original setting.

Just like pages, the checkboxes 1701 are zoomed when the user changes the preview zoom options. It is noted in the present context that “zoom” refers to the size at which pages and checkboxes are displayed in the print preview, and not to the scale factor of content within those pages. Desirably, the custom print application has zoom options from 10% to 500%. The user can, for example, select one of zoom options from a preview zoom combo box. To avoid the checkboxes 1701 becoming too small to select, the checkboxes 1701 may have a minimum zoom limit. That is,
1. When the user selects a zoom option greater than or equal to 100%, then the zoom option is applied to the checkboxes 1701 and their associated text label.
2. When the user selects a zoom option less than 100%, the checkboxes and their associated text labels are displayed at a 100%, or other predetermined value of zoom factor.

When all checkboxes 1701 are deselected, the Print button 110 will be disabled and will be greyed out. The Print button 110 becomes enabled whenever one or more page checkboxes 1701 is selected.

When the user clicks the Print button 110 when in an enabled-state, a print dialog (not illustrated, but well known in the art) is configured to pop up and be displayed within the GUI. The options in “Page Range” of the dialog are desirably made consistent with the page selection in the preview afforded by the custom print application. That is,
1. If all checkboxes 1701 are selected in the custom print preview, the custom print application sets the “Page Range” option so that the “All” selector button in the “Page Range” of the printer dialog will be selected and the “Selection” selector button is greyed out.
2. If not all of checkboxes are selected in the custom print preview, the custom print application sets the “Page Range” option so that the “Selection” selector button is enabled and selected and the “All” selector button is enabled but deselected.

If the user selects the “All” selector button in the “Page Range” and then clicks via the mouse 203 the “Print” button in the printer dialog, the custom print application will print all pages while keeping all states of checkboxes 1701 unchanged.

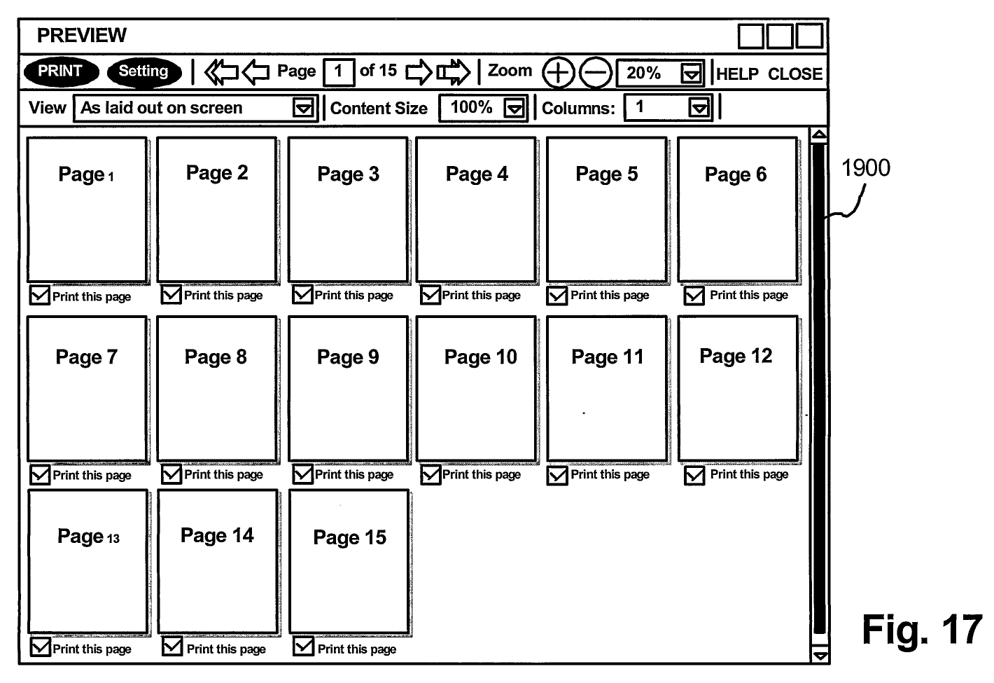

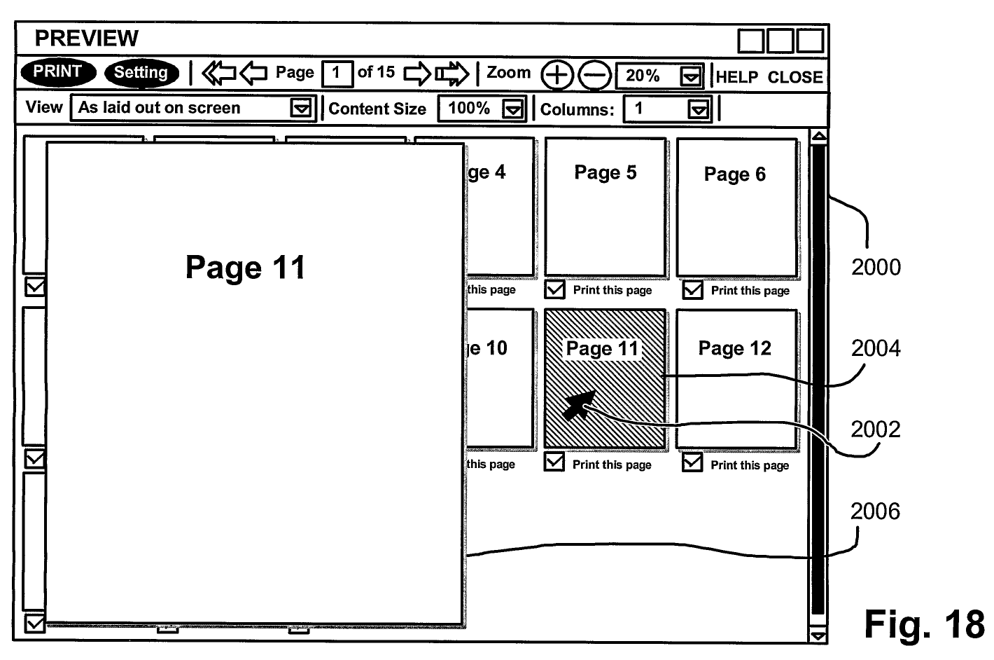

FIG. 17 shows a preview 1900 at 20% zoom rate automatically being chosen when there are many pages so that a user can overview and navigate as many pages as possible. However, as will be appreciated, the content of each page is hardly legible. The user may change to a bigger zoom value to read a particular page, but it will relinquish the benefits with 20% zoom to view all pages or as many as possible of the entire document. As an solution to this problem, a legible copy of the page of interest may be provided temporarily and can be dismissed without changing the preview scene. One implementation to achieve this is described as follows with reference to FIG. 18.

When the user moves the mouse 203 in a GUI 2000, and thus the corresponding pointer/cursor 2002, over a page 2004 desired to be reviewed or read, and the cursor remains over the page 2004 for a predetermined time period, for example, 1.5 second, an enlarged copy 2006 of the page is displayed above the original page as shown in FIG. 18. The enlarged page copy 2006 has its height arranged close to but not larger than the height of the preview window 2000. Therefore, the user can read the entire page content without any extra action. The user can dismiss the enlarged copy 2006 by moving the mouse cursor 2002 away from both the page copy 2006 and/or the original page 2004.

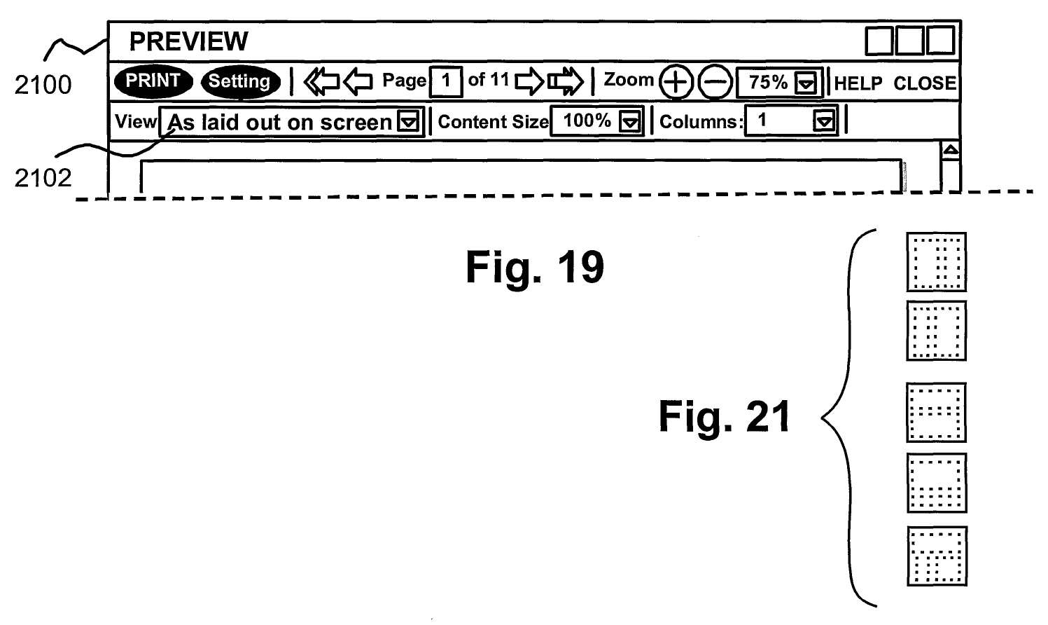

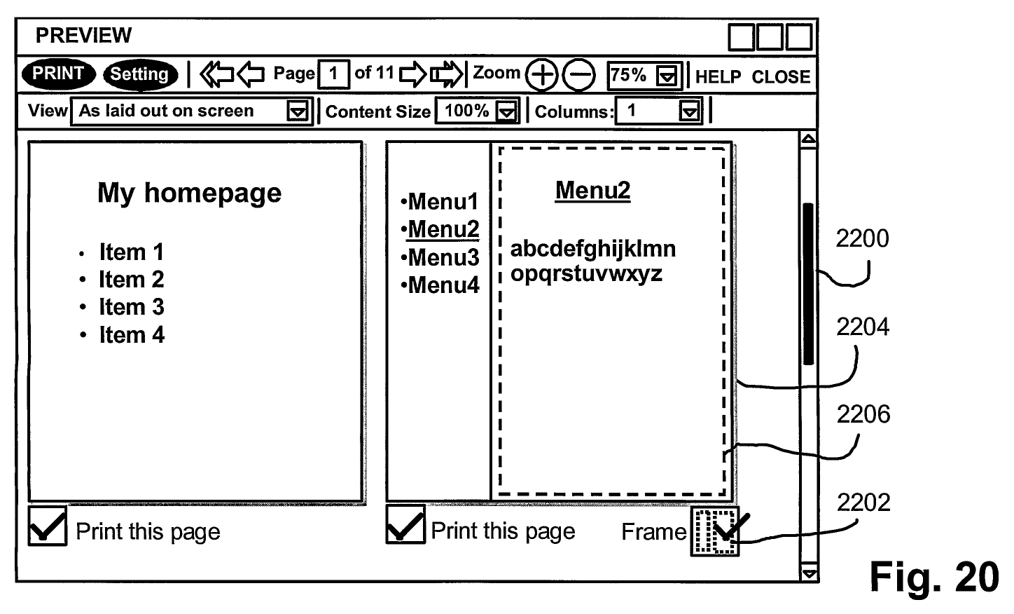

FIG. 19 shows a GUI 2100 provided to allow the user to switch the view between “As laid out on screen” 2102 and “Only the selected frame” (not illustrated) because some web pages in the preview may contain frame(s). The pages containing frames have a frame page indicator 1705, located at the right-hand side corner just below the pages 1702, 1703 as shown in FIG. 15. The indicator 1705 can be arranged so that the indicator 1705 represents framing horizontally if the frames on the page 1702, 1703 are horizontally organized. The same applies for vertical frames and to any combination of the two. The user can therefore knowingly select a particular frame by looking at the indicator 1705. The user may then select one or more frames for printing using the mouse 203 and corresponding cursor/pointer. As shown in FIG. 20, for a GUI 2200, when the frame indicator 2202 is checked, the corresponding frame 2204 is highlighted by a surrounding dash-lined rectangle 2206 indicating such is selected for printing.

FIG. 21 shows various layouts for the frames indicator 1705 each of which may be used in an implementation of the custom print application depending upon the frame arrangement of the particular page.

### INDUSTRIAL APPLICABILITY

The arrangements described are applicable to the computer and data processing industries and particularly those involving the printing of data sourced from computer networks. The disclosure is directly applicable to web browsing applications and the printing of data sourced using such applications.

The foregoing describes only some embodiments of the present invention, and modifications and/or changes can be made thereto without departing from the scope and spirit of the invention, the embodiments being illustrative and not restrictive.

For example, the implementations discussed above describe scaling the entire content to fill a whole number of pages. This is done to ensure uniformity of presentation essentially consistent with the original presentation for a traditional print. However, all pages need not be scaled. In a multi-page document, only the last “page” of content need be scaled to ensure an appropriate fit and avoid minor overflow. This however will result in a greater amount of scaling (smaller scale ratio) which may be quite evident in comparison with those page that were not subject to scaling.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method of printing a document, said document comprising a plurality of pages sourced from a computer network, said method comprising the steps of:
providing a zoom property attribute to scale the document;
displaying a preview window which shows the pages in the document the content of which is scaled based on the zoom property attribute;
determining a user selection, within the preview window, for the pages of the scaled document; and
printing a subset of the pages according to the user selection.

2. A method according to claim 1, wherein the user preference is determined for each page.

3. A method according to claim 1, wherein the user preference is determined by using a checkbox.

4. A method according to claim 3, wherein the checkbox is in a vicinity of the previewed pages.

5. A method of printing a multi-page document sourced from a computer network, said method comprising the steps of:
providing a zoom property attribute to scale the multi-page document;
determining whether an amount of content on a last page of a scaled multi-page document, which is scaled based on the zoom property attribute, is less than a predetermined amount; and
when the amount of content is less than the predetermined amount, further scaling the scaled multi-page document down to fit to a nearest whole page and printing the further scaled multi-page document.

6. A computer readable medium, having a program recorded thereon, where the program is configured to make a computer execute a procedure to print a multi-page document sourced from a computer network, said program comprising the steps of:
code for providing a zoom property attribute to scale the document;
code for displaying a preview window which shows the pages in the document the content of which is scaled based on the zoom property attribute;
code for determining whether an amount of content on a last page of a scaled multi-page document, which is scaled based on the zoom property attribute, is less than a predetermined amount; and
code for further scaling the scaled multi-page document down to fit to a nearest whole page when the amount of content is less than the predetermined amount; and
code for printing the further scaled multi-page document.

7. A computer readable medium according to claim 6 further comprising:
code for determining a user selection, within the preview window, for the pages of the scaled document; and
code for printing a subset of the pages according to the user selection.

8. A method of printing a document sourced from a computer network and spanning a plurality of printable pages, said method comprising the steps of:
determining whether an amount of content on a last page of said printable pages is less than a predetermined amount;
when the determined amount of content is less than the predetermined amount, scaling the content down to fit the content to the nearest whole page; and
printing the content.

9. A method according to claim 8 wherein the nearest whole page is the plurality less one, and if the determined amount of content is greater than said predetermined amount, then printing said plurality of pages, and wherein if the content on the last page is less than the predetermined amount, said method comprises the further step, before said scaling, of:
determining a user preference for one of scaling the content to fit the nearest whole page or printing said plurality of pages.

10. A method according to claim 9 wherein said determining comprises presenting a dialog box to the user within a graphical user interface whereby the user can select one of scaling the content to fit the nearest whole page or printing said plurality of pages, said method being performed in conjunction with a graphical user interface arranged to display both a print preview of said document spanning said plurality of pages and a print preview of said document scaled to said nearest whole page.

11. A method according to claim 10 further comprising the step of detecting a user selection of one of said print previews and printing the selected print preview.

12. A method according to claim 8 wherein said predetermined amount is user adjustable, said method further comprising the step of presenting a graphical user interface including a value of said predetermined amount and detecting a user's change to said amount made via said graphical user interface.

13. A method according to claim 12 wherein said graphical user interface comprises at least one of a numerical representation of said value and a user manipulable graphical representation of said value.

14. A method according to claim 13 further comprising representing said predetermined amount within a bounding area in a graphical user interface and detecting manipulation of said bounding area by the user, said manipulation thereby at least adjusting a scale factor for said scaling.

15. A printing application program arranged for printing a document sourced from a computer network and spanning a plurality of printable pages, said program comprising:
code arranged to determine whether an amount of content on a last page of said printable pages is less than a predetermined amount;
code, operable when the amount of content is less than the predetermined amount, for scaling down the content to fit the content to the nearest whole page; and
code for printing the content.

16. A printing application program according to claim 15 wherein the nearest whole page is the plurality less one, said program further comprising code, operable when the amount of content is greater than said predetermined amount, for printing said plurality of pages.

17. A printing application program according to claim 16 wherein said computer network comprises the World Wide Web and said printing application program is configured to interact with a web browser application program having an associated graphical user interface, said printing application program further comprising code arranged to display via said graphical user interface both a print preview of said document spanning said plurality of pages and a print preview of said document scaled to said nearest whole page.

18. A printing application program according to claim 17 further comprising code for detecting a user selection of one of said print previews and printing the selected print preview.

19. A printing application program according to claim 17 further comprising code for presenting a subsidiary graphical user interface box within said graphical user interface of said web browser application whereby a user thereof can select one of scaling the content to fit the nearest whole page or printing said plurality of pages.

20. A printing application program according to claim 19 wherein said subsidiary graphical user interface comprises a dialog box including a user manipulable graphical representation of predetermined amount.
